(19) United States
(12) Patent Application Publication
(10) Pub. No.: US 2010/0057268 A1
(43) Pub. Date: Mar. 4, 2010

(54) METHOD AND MODEL FOR EVALUATING TRANSMISSION ULTRACAPACITORS IN POWER SYSTEMS

(75) Inventors: Jeffrey W. Smith, Knoxville, TN (US); Kyung Soo Kook, Knoxville, TN (US)

Correspondence Address: TREGO, HINES & LADENHEIM, PLLC, 9300 HARRIS CORNERS PARKWAY, SUITE 210, CHARLOTTE, NC, 28269-3797, US

(73) Assignee: ELECTRIC POWER RESEARCH INSTITUTE, INC., Charlotte, NC (US)

(21) Appl. No.: 12/200,992

(22) Filed: Aug. 29, 2008

(51) Int. Cl. G05B 17/02; G06F 17/10

(52) U.S. Cl. 700/298; 700/297; 703/2

(57) ABSTRACT

A method and model for evaluating transmission ultracapacitor response in a power system. The method includes the steps of implementing a transmission ultracapacitor model into power system simulation software, simulating a desired condition of a power system, and determining a desired output power of a transmission ultracapacitor to define a control setpoint. The method further includes the steps of determining the transmission ultracapacitor limit, such that the desired output power does not exceed the transmission ultracapacitor limit, responding to the condition by adjusting output according to the control setpoint, and using the output in conjunction with other elements in the power system to determine an overall system response.

### BACKGROUND OF THE INVENTION

The present invention relates generally to a method and model for evaluating transmission ultracapacitor response in a power system. More particularly, the invention relates to a method and model that evaluates the charge and discharge characteristics and the operating limits of a transmission ultracapacitor for power system studies in a time domain.

A transmission ultracapacitor is essentially a voltage-dependent current source, of which the current is dependent upon the inverse of the voltage across the equivalent capacitor. Unlike most other forms of constant power generation that can be simplified to a constant voltage behind an equivalent impedance, the transmission ultracapacitor is somewhat more involved in that the equivalent voltage source is dependent upon how much energy is stored in the transmission ultracapacitor and the magnitude and direction of current flowing at a given point in time.

Transmission ultracapacitors are advantageous because they have the ability to store active power, which may be injected (discharged) or absorbed (charged) by a transmission ultracapacitor on a sub-cycle (50 Hz or 60 Hz) basis. Transmission ultracapcitors may also be charged to a voltage above their rating for a short period of time to allow them to absorb above rated power for a short duration. Thus, transmission ultracapacitors can be very beneficial in isolated systems that contain fast variations in active power due to their ability to absorb or inject active power as needed to balance energy and regulate power system frequency.

In order to evaluate the performance of a transmission ultracapacitor during electrical grid disturbances, a method and model that evaluates important charge and discharge characteristics and operating limits of transmission ultracapacitors is needed. Unfortunately, existing models are not applicable to a large number of strings of ultracapacitors and associated control circuits that constitute a transmission ultracapacitor.

Accordingly, there is a need for a simplified method and model that may be easily implemented into most commercially-available software tools used to study power systems.

### BRIEF SUMMARY OF THE INVENTION

These and other shortcomings of the prior art are addressed by the present invention, which provides a simplified method and model for evaluating the performance of transmission ultracapacitors.

According to one aspect of the present invention, a method of evaluating transmission ultracapacitors includes the steps of implementing a transmission ultracapacitor model into power system simulation software; simulating a desired condition of a power system; responding to the condition by adjusting output according to a control setpoint; and determining an overall system response.

According to another aspect of the invention, a method of evaluating transmission ultracapacitors includes the steps of implementing a transmission ultracapacitor model into power system simulation software, simulating a desired condition of a power system, and determining a desired output power of a transmission ultracapacitor to define a control setpoint. The method further includes the steps of determining the transmission ultracapacitor limit, such that the desired output power does not exceed the transmission ultracapacitor limit; responding to the condition by adjusting output according to the control setpoint; and using the output in conjunction with other elements in the power system to determine an overall system response.

### BRIEF DESCRIPTION OF THE DRAWINGS

The subject matter that is regarded as the invention may be best understood by reference to the following description taken in conjunction with the accompanying drawing figures in which:

FIG. 1 is a control circuit illustrating calculation of current and losses based upon a defined output power;

FIG. 2 is a control diagram for calculating a maximum charge and discharge capability of a transmission ultracapacitor;

FIG. 3 is an overall control diagram illustrating a mathematical representation of a transmission ultracapacitor model; and

FIG. 4 shows the response of the transmission ultracapacitor model from a set control signal (desired output).

### DETAILED DESCRIPTION OF THE INVENTION

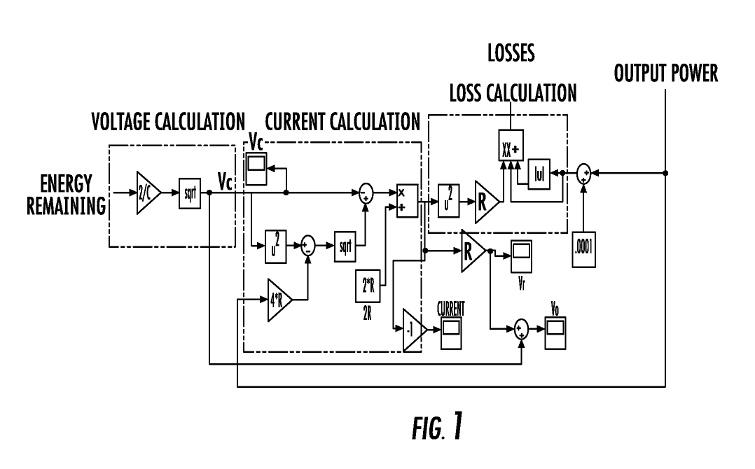

Referring to the drawings, an exemplary method and model for evaluating transmission ultracapacitors according to an embodiment of the invention is illustrated in FIGS. 1-3.

When modeling any physical system, all relative components must be modeled appropriately to represent as accurately as possible the overall system response. In addition, it is important to simulate a physical system under various conditions. Likewise, to simulate the response of a transmission ultracapacitor in a power system model, an accurate model of the transmission ultracapacitor is necessary to represent the interaction of the transmission ultracapacitor with the other elements in the power system model.

To implement a transmission ultracapacitor model that is compatible with most common power system simulation software platforms, it is preferred that the entire model be reduced to simple transfer functions. In order to reduce an equivalent down to a simple transfer function, an assumption is made that during each time step, the voltage across an equivalent capacitance is held constant and calculated based upon the energy remaining in the transmission ultracapacitor. Upon making this assumption, the remainder of the equivalent circuit current and losses can be solved using simple algebraic equations, as is shown in FIG. 1. As shown, there are two known variables or inputs—the energy remaining in the device and the desired output power.

Using the energy equation (Energy=0.5*C*V²), the voltage across the transmission ultracapacitor (V_{C}) can be calculated using:

$${V}_{C} = \sqrt{\frac{2 \cdot E}{C}} \qquad Eq . 1$$

where Vc is the voltage across an equivalent transmission ultracapacitor; C is the capacitance of the equivalent transmission ultracapacitor; and E is the energy remaining in the equivalent transmission ultracapacitor.

With the voltage across the equivalent transmission ultracapacitor known, the current can be found using the following equation:

$${I}^{2} + \frac{{V}_{C} \cdot I}{R} + \frac{W}{R} = 0 \qquad Eq . 2$$

where R is the equivalent series resistance and W is the desired output power.

Losses are then found by multiplying the equivalent series resistance times the current squared.

With the losses being known, the energy remaining in the transmission ultracapacitor is calculated using a simple energy equation, where: E(t)=E(t−1)−Energy(delivered)−Energy(losses).

The desired output power is determined by a controller which defines a setpoint at each simulation time step. This setpoint is the desired output of the transmission ultracapacitor and serves as the input to the transmission ultracapacitor model. The model calculates whether this desired output can be achieved based upon the characteristics of the transmission ultracapacitor. If the desired output is achievable without exceeding the transmission ultracapacitor limits, then the transmission ultracapacitor model will deliver the desired output to the power system model. If the desired output cannot be achieved due to transmission ultracapacitor limits, the model output is limited to the nearest point to that which is desired without exceeding limits.

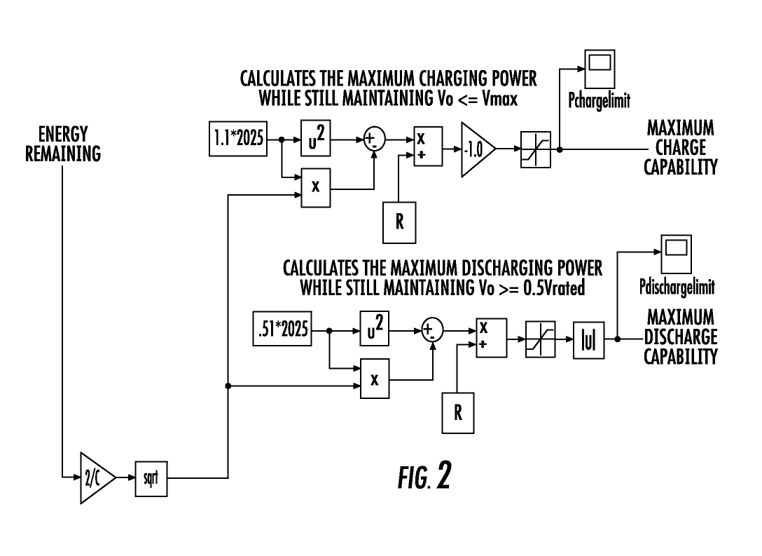

In order to ensure the transmission ultracapacitor does not operate outside of it's defined voltage limits, the maximum power output (discharge) and input (charge) are calculated based upon fixed voltage limits and energy remaining in the ultracapacitor, as shown in FIG. 2. The same basic equation is used, as shown in Eq. 2, with the exception that V_{C} is fixed to either the maximum operating voltage for calculating the maximum charge or the minimum voltage for calculating the maximum discharge capability. Once this is determined at each time step, the limits on the charge and discharge capability are applied. The diagram shown in FIG. 2 assumes a nominal float voltage of the ultracapacitor strings of 2025 volts.

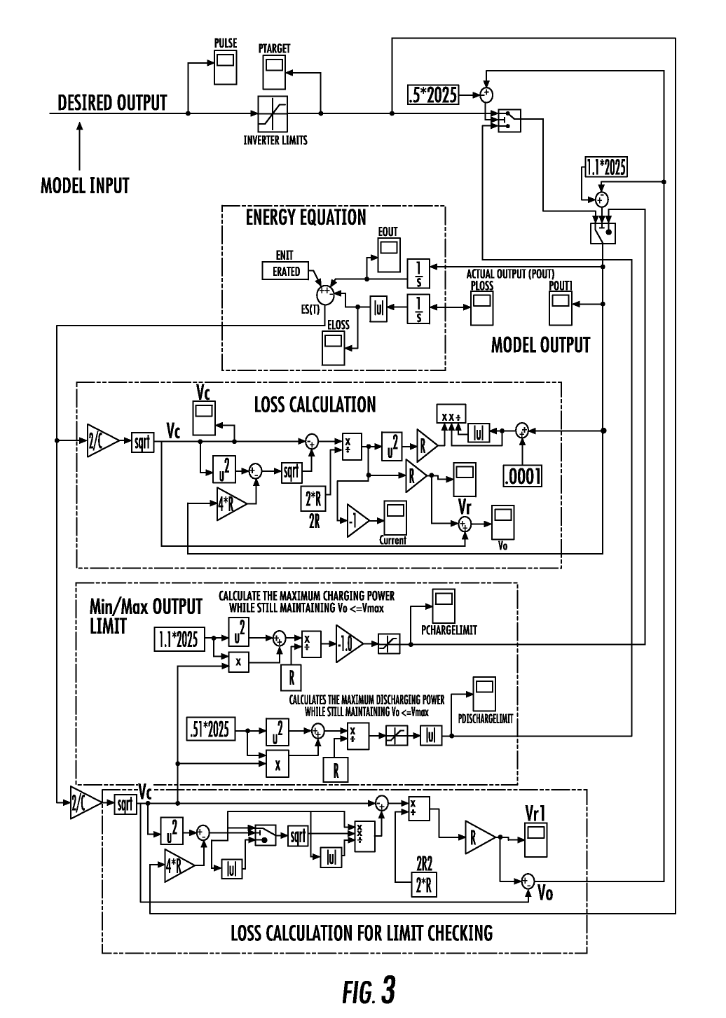

FIG. 3 illustrates the overall implementation of the transmission ultracapacitor model, including the input and output, loss calculation, loss calculation implementation for limit checking, energy equation, and the minimum and maximum output calculations at operating limits.

In use, the model represents the transmission ultracapacitor response to a desired output. This is done by implementing the transmission ultracapacitor model in new or existing power system simulation software installed on a computing device used to monitor and control a power system. The transmission ultracapacitor model simulates a desired condition of the power system (i.e., contingency event such as loss of element, change in element output, etc.), and responds to the system condition by adjusting output according to the control setpoint (desired output) and transmission ultracapacitor characteristics. The transmission ultracapacitor output (active power) is then used in conjunction with other elements in the power system to determine an overall system response.

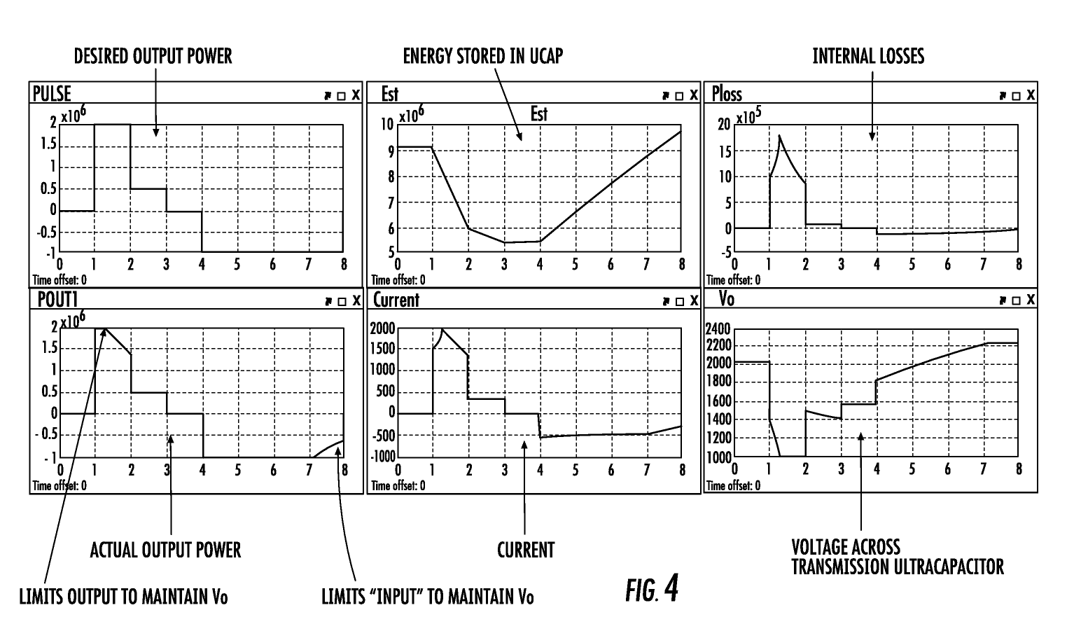

Referring to FIG. 4, with the model installed, results of the transmission ultracapacitor model for a defined desired output may be created to evaluate the performance of a transmission ultracapacitors. For example, the model can show actual output power (pulse), actual output power (pout1), energy stored in the ultracapacitor (est.), current, internal losses (Ploss), and voltage across the transmission ultracapacitor (Vo). For clarity, it should be appreciated that:
1. Actual Output Power (Pulse)=the control signal sent to the transmission ultracapacitor;
2. Actual Output Power (Pout1)=the power delivered (or absorbed) by the transmission ultracapacitor;
3. Energy Stored in the UCAP (Est)=the actual energy remaining in the transmission ultracapacitor;
4. Current=the actual current flowing in the equivalent transmission ultracapacitor;
5. Internal Losses (Ploss)=the calculated losses found by multiplying the equivalent series resistance times the current squared; and
6. Voltage Across the Transmission Ultracapacitor (Vo)=the voltage across the equivalent transmission ultracapacitor, including the equivalent series resistance.

The foregoing has described a method and model for transmission ultracapacitors. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

What is claimed is:

1. A method of evaluating transmission ultracapacitors, comprising the steps of:
(a) implementing a transmission ultracapacitor model into power system simulation software;
(b) simulating a desired condition of a power system;
(c) responding to the condition by adjusting output according to a control setpoint; and
(d) determining an overall system response.

2. The method according to claim 1, further including the step of using simple transfer functions to calculate an equivalent circuit current and losses.

3. The method according to claim 1, further including the step of calculating voltage across a transmission ultracapacitor using:
$${V}_{C} = \sqrt{\frac{2 \cdot E}{C}} .$$

4. The method according to claim 1, further including the step of calculating current across a transmission ultracapacitor using:
$${I}^{2} + \frac{{V}_{C} \cdot I}{R} + \frac{W}{R} = 0.$$

5. The method according to claim 1, further including the step of calculating energy remaining in a transmission ultracapacitor using:
E(t)=E(t−1)−Energy(delivered)−Energy(losses).

6. The method according to claim 1, further including the step of calculating losses.

7. The method according to claim 1, further including the step of calculating a maximum power output.

8. The method according to claim 1, further including the step of calculating a maximum input power.

9. The method according to claim 1, further including the step of determining a desired output power of the transmission ultracapacitor.

10. The method according to claim 1, further including the step of determining a transmission ultracapacitor limit.

11. A method of evaluating transmission ultracapacitors, comprising the steps of:
(a) implementing a transmission ultracapacitor model into power system simulation software;
(b) simulating a desired condition of a power system;
(c) determining a desired output power of a transmission ultracapacitor to define a control setpoint;
(d) determining the transmission ultracapacitor limit, such that the desired output power does not exceed the transmission ultracapacitor limit;
(e) responding to the condition by adjusting output according to the control setpoint; and
(f) using the output in conjunction with other elements in the power system to determine an overall system response.

12. The method according to claim 11, further including the step of using simple transfer functions to calculate an equivalent circuit current and losses by holding a constant voltage across an equivalent capacitance based on energy remaining in the transmission ultracapacitor.

13. The method according to claim 11, wherein the step of determining the transmission ultracapacitor limit includes the step of calculating a maximum power output and maximum input power.

14. The method according to claim 13, wherein the maximum power output is determined using a fixed minimum operating voltage of the transmission ultracapacitor.

15. The method according to claim 13, wherein the maximum input power is determined using a fixed maximum operating voltage of the transmission ultracapacitor.

16. The method according to claim 11, wherein if the desired output exceeds the transmission ultracapacitor limit then the desired output is defined at a point below the limit.
